(19) United States
(12) Patent Application Publication
(10) Pub. No.: US 2020/0387847 A1
(43) Pub. Date: Dec. 10, 2020

(54) Operation Plan Generation Device and Operation Plan Generation Method

(71) Applicant: Hitachi, Ltd., Chiyoda-ku, Tokyo (JP)

(72) Inventors: Tsutomu KAWAMURA, Tokyo (JP); Masatoshi KUMAGAI, Tokyo (JP); Hirotaka TAKAHASHI, Tokyo (JP)

(21) Appl. No.: 16/957,300

(22) PCT Filed: Nov. 26, 2018
(86) PCT No.: PCT/JP2018/043365

§ 371 Date: Jun. 23, 2020

(30) Foreign Application Priority Data
Feb. 15, 2018 (JP) 2018-024847

(51) Int. Cl. G06Q 10/06; G06Q 10/10; G06Q 50/06; G06Q 10/04; G06N 20/00; G05B 19/042; F24F 11/46; F24F 11/65

(52) U.S. Cl. CPC G06Q 10/06375; G06Q 10/10; G06Q 10/06393; G06Q 50/06; G06Q 50/163; G06N 20/00; G05B 19/042; F24F 11/46; F24F 11/65; G06Q 10/04

(57) ABSTRACT

An operation plan generation device in an energy system that supplies energy to a consumer is provided with: a data generation unit that generates, on the basis of a plurality of operation conditions for the energy system, a plurality of operation plans with respect to the respective operation conditions, and calculates KPIs corresponding to the respective operation plans; a machine learning unit that learns characteristics of the energy system on the basis of the operation plans and the KPIs; and an operation plan generation unit that generates an operation plan on the basis of the learned characteristics of the energy system.

### TECHNICAL FIELD

The present invention relates to an operation plan generation device and an operation plan generation method for an energy system.

### BACKGROUND ART

In recent years, needs of microgrids (or energy systems) that supply energy to consumers by combining a plurality of apparatuses such as renewable energy apparatuses, cogeneration systems, heat source devices, energy storage apparatuses for a purpose of reducing energy costs and CO₂ emission amounts are increasing. An operation of a microgrid is managed by an energy management system, and each apparatus is controlled to perform an appropriate operation on the basis of an operation plan generated so as to reduce the operation costs, the CO₂ emission amounts, or the like. In particular, in North America, introduction of a self-sustaining resilient microgrid is also being promoted in case of power outages or the like due to natural disasters.

For example, PTL 1 discloses an operation plan generation device that realizes energy saving and reduction of CO₂ emission amounts in an energy plant by generating an optimal operation plan of waste heat utilization heat source equipment on the basis of energy consumption characteristics that change according to a used amount of waste hot water.

### CITATION LIST

### Patent Literature

PTL 1: JP-A-2015-203531

### SUMMARY OF INVENTION

### Technical Problem

However, there is a problem that as the number of apparatuses in the microgrid (or the energy system) increases, a time required for an operation plan generation device to generate an operation plan increases.

The invention is made in order to solve the above-described problem, and an object of the invention is to provide an operation plan generation device or the like that can reduce a time required for generating an operation plan.

### Solution to Problem

In order to solve the above-described problem, an operation plan generation device according to an embodiment of the present disclosure is an operation plan generation device in an energy system that supplies energy to a consumer. The operation plan generation device includes: a data generation unit configured to generate, on the basis of a plurality of operation conditions for the energy system, a plurality of operation plans with respect to the respective operation conditions, and calculate KPIs corresponding to the respective operation plans; a machine learning unit configured to learn characteristics of the energy system on the basis of the plurality of operation plans and the KPIs; and an operation plan generation unit configured to generate an operation plan on the basis of the learned characteristics of the energy system.

### Advantageous Effect

According to the invention, an operation plan generation device or the like that can reduce a time required for generation of an operation plan can be provided.

### BRIEF DESCRIPTION OF DRAWINGS

FIG. 1A is a diagram showing an example of a configuration of a microgrid according to a first embodiment.

FIG. 1B is a diagram showing that a generator of FIG. 1A is configured with a plurality of generators.

FIG. 2 is a functional block diagram of an operation plan generation device according to the first embodiment.

FIG. 3 is a diagram showing an operation plan generated by a data generation unit according to the first embodiment.

FIG. 4 is a diagram showing the operation plan generated by the data generation unit according to the first embodiment.

FIG. 5 is a diagram showing the operation plan generated by the data generation unit according to the first embodiment.

FIG. 6 is a diagram showing KPIs calculated by the data generation unit according to the first embodiment.

FIG. 7 is a flowchart showing a flow of calculation processing in the operation plan generation device according to the first embodiment.

FIG. 8 is a functional block diagram of an operation plan generation device according to a second embodiment.

FIG. 9 is a diagram showing a relationship between an optimal solution and an operation plan candidate generated by an operation plan candidate generation unit according to the second embodiment.

FIG. 10 is a flowchart showing a flow of calculation processing in the operation plan generation device according to the second embodiment.

### DESCRIPTION OF EMBODIMENTS

An example of an embodiment to which the invention is applied will be described. Hereinafter, in all the drawings for describing the embodiments, components having the same functions are denoted by the same reference numerals unless otherwise specified, and repeated description will be omitted. Further, the invention is not limited by the following description.

### First Embodiment

### «Overall Configuration of Microgrid»

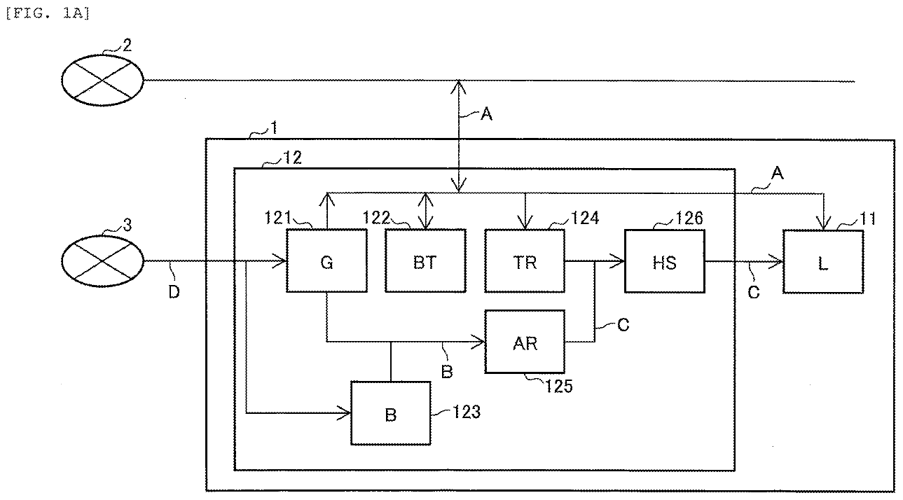

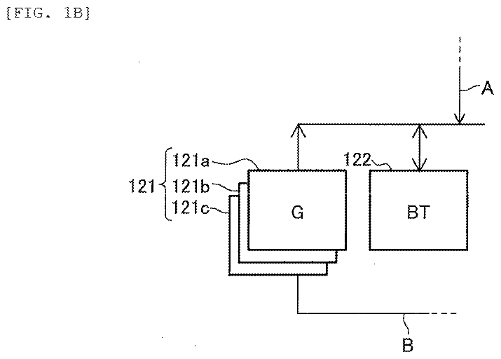

A configuration of a microgrid 1 according to the present embodiment will be described with reference to FIG. 1A.

The microgrid 1 includes a consumer 11 and an energy system 12 that supplies a plurality of types of energy to the consumer 11, and implements an energy supply system for a consumer. In this example, the energy supplied by the energy system 12 to the consumer 11 is a power A and a heat C (for example, a cold water at about 5° C. to 7° C.). The consumer 11 is equipment that consumes a heat and a power, such as a factory, an office building, a mansion, a university, or the like. The energy system 12 includes a generator 121, a storage battery 122, a boiler 123, a turbo chiller 124, a waste heat utilization absorption chiller 125, a heat storage tank 126, or the like.

The microgrid 1 is connected to a power system 2 and a gas system 3, and an operation of the microgrid 1 is managed by an energy management system. The energy management system is appropriately classified according to a scale of the consumer 11, and for example, a factory energy management system (FEMS) for a factory, a building energy management system (BEMS) for a building, a mansion energy management system (MEMS) for a mansion, and a home energy management system (HEMS) for an ordinary home are known.

The generator 121 is connected to the power system 2 and supplies the power A to the consumer 11. For example, about 60% of the power supplied to the consumer 11 is covered by the generator 121, and about 40% of the power is covered by a purchased power purchased from a power company. Further, the generator 121 is connected to the gas system 3, generates a hot water B (a waste heat B) using a gas D supplied from the gas system 3 as a fuel, and supplies the hot water B to the waste heat utilization absorption chiller 125. Examples of the generator 121 include a gas turbine generator, a gas engine generator, and a fuel cell. As shown in FIG. 1B, the generator 121 includes a plurality of generators (first generator 121a to third generator 121c).

The storage battery 122 and the heat storage tank 126 function as energy storage equipment. The storage battery 122, for example, can store the power A during night when an electricity rate is low, and discharge the power A during daytime when the electricity rate is high. Examples of the storage battery 122 include a lithium-ion battery. The heat storage tank 126 stores the cold water C (heat C) supplied from the turbo chiller 124 and the waste heat utilization absorption chiller 125, and appropriately supplies the cold water C to the consumer 11.

The boiler 123 is connected to the gas system 3, generates the hot water B using the gas D supplied from the gas system 3 as a fuel, and supplies the hot water B to the waste heat utilization absorption chiller 125. The turbo chiller 124 is driven by the power A supplied from the generator 121 or the power system 2 to generate the cold water C, and supplies the cold water C to the heat storage tank 126. The waste heat utilization absorption chiller 125 is driven by a waste heat discharged from the generator 121 or a heat generated by the boiler 123 using the gas D as a fuel to generate the cold water C, and supplies the cold water C to the heat storage tank 126. When the electricity rate is low, it is preferable to generate the cold water C by using the turbo chiller 124 driven by the power A from the purchased power, and when the electricity rate is high, it is preferable to generate the cold water C by using the turbo chiller 124 driven by the power A from the generator 121 using the gas D as a fuel . Alternatively, it is preferable to generate the cold water C by using the waste heat utilization absorption chiller 125 that utilizes the heat generated by the generator 121 or the boiler 123 using the gas D as a fuel.

As described above, the microgrid 1 realizes an optimal operation of the energy system 12 so as to minimize an operation cost by the energy management system.

### «Configuration of Operation Plan Generation Device»

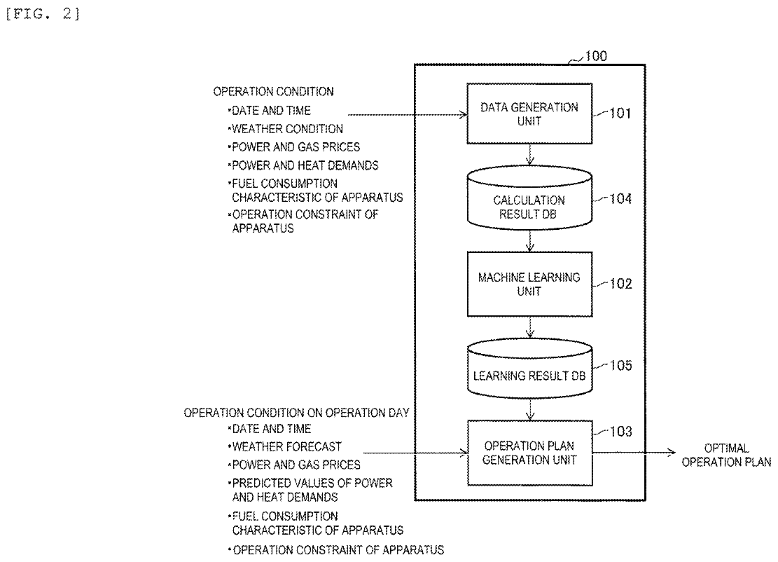

Next, an example of a configuration of an operation plan generation device 100 that is one function of the energy management system managing the operation of the microgrid 1 will be described with reference to FIG. 2.

The operation plan generation device 100 can mutually perform information communication with the microgrid 1 via the Internet, a wire LAN, a wireless LAN, or the like. The operation plan generation device 100 transmits a control value to the energy system 12 according to an energy demand (for example, a power demand, a heat demand) received from the consumer 11, and controls operations of apparatuses in the microgrid 1.

The operation plan generation device 100 includes a calculation processing unit, a storage unit, or the like. The calculation processing unit functions as a center of the operation plan generation device 100, includes, for example, a central processing unit (CPU), and performs predetermined calculation processing by reading a control program stored in the storage unit, expanding the control program in a work area, and executing the control program. The storage unit includes, for example, a read only memory (ROM) and a random access memory (RAM), and is used as a work storage area for the calculation processing unit to execute the control program.

Specifically, the operation plan generation device 100 includes a data generation unit 101, a machine learning unit 102, an operation plan generation unit 103, a calculation result database (DB) 104, a learning result DB (database) 105, or the like.

The data generation unit 101 obtains, from the energy management system, various operation conditions fora large number of different cases for the energy system 12 in order to generate a large number of calculation results required by the machine learning unit 102, and generates an operation plan on the basis of the operation conditions for each of the cases. The operation plan is a plan for devising a combination of each apparatus so as to reduce the operation cost or the like and causing each apparatus to appropriately operate. For example, the plan is to cause the storage battery 122 to appropriately operate in order to store the purchased power purchased from the power company in the storage battery 122 during the night when the electricity rate is low. Further, for example, the plan is to cause the storage battery 122 to operate at 50% output (discharge) for 5 hours after causing the generator 121 to operate at 30% output for 2 hours according to the power demand and the heat demand from the consumer 11.

Incidentally, the data generation unit 101 generates an operation plan that satisfies operation constraint conditions for the energy system 12 and an operation plan that violates the operation constraint conditions for the energy system 12. This point, that is, the point of the operation plan violating the operation constraint conditions is different from an operation plan generated by the operation plan generation unit 103 described later. Further, the data generation unit 101 outputs the generated operation plan to the calculation result DB 104, and stores the generated operation plan in the calculation result DB 104. The operation constraint conditions include, for example, a minimum load factor of each apparatus, an upper limit value of the number of start and stop times per day of each apparatus, an operation continuation time after a start of each apparatus, a stop continuation time after a stop, and an upper limit value of a purchased power (contract power).

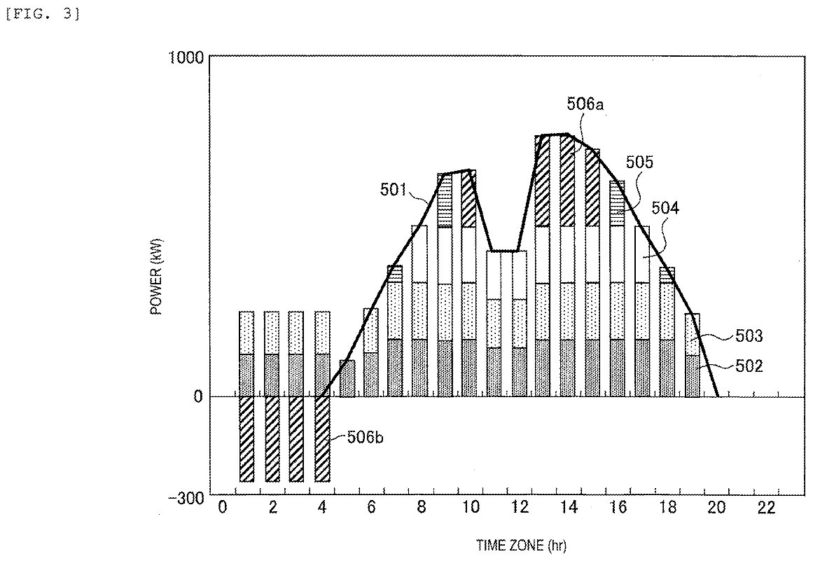

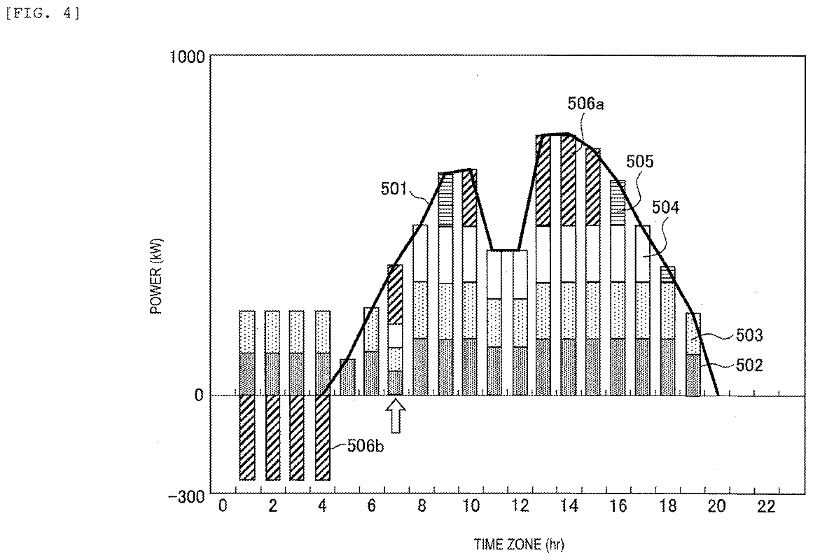

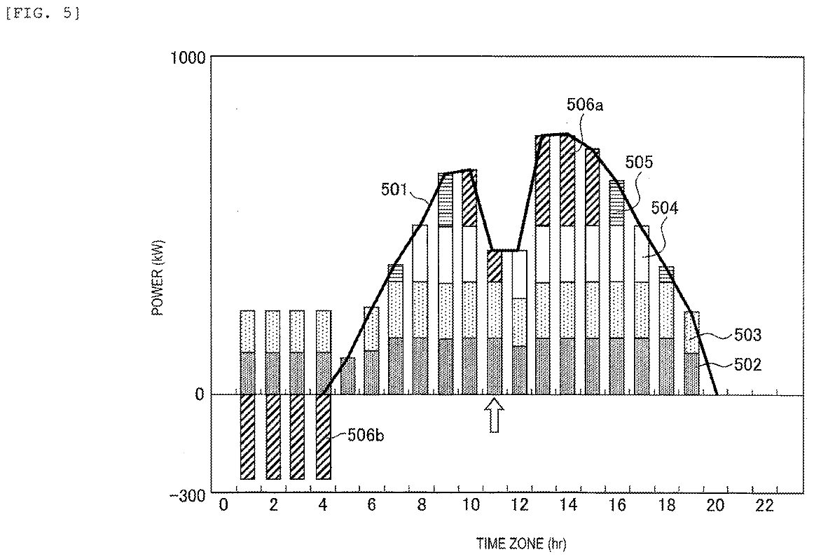

Here, the operation plan generated by the data generation unit 101 will be described with reference to FIGS. 3 to 5. FIG. 3 is a diagram showing an example of the operation plan that satisfies the operation constraint conditions for the energy system 12. FIGS. 4 and 5 are diagrams showing an example of the operation plan that violates the operation constraint conditions for the energy system 12. A horizontal axis indicates a time zone [hr], and a vertical axis indicates a power [kW].

Aline graph 501 indicates the power demand of the consumer 11 for the energy system 12. A bar graph 502 indicates a generated power of the first generator 121a. A bar graph 503 indicates a generated power of the second generator 121b. A bar graph 504 indicates a generated power of the third generator 121c. A bar graph 505 indicates a purchased power of the microgrid 1. A bar graph 506a indicates a discharge power of the storage battery 122. A bar graph 506b indicates a stored power of the storage battery 122.

The power demand of the consumer 11 for the energy system 12 is covered by the generated power of the generator 121, the discharge power of the storage battery 122, and the purchased power from the power system 2. A price of the purchased power depends on a contract with the power company, a time zone throughout a day, or the like.

As shown in FIGS. 3, at 20:00, 21:00, 22:00, 23:00, 0:00, 1:00, 2:00, 3:00, and 4:00, the power demand (reference numeral 501) of the consumer 11 is zero. At 1:00, 2:00, 3:00, and 4:00, the stored power (reference numeral 506b) of the storage battery 122 is covered by the generated power (reference numeral 502) of the first generator 121a and the generated power (reference numeral 503) of the second generator 121b. At 5:00, the power demand of the consumer 11 is covered by the generated power of the first generator 121a. At 6:00 and 19:00, the power demand of the consumer 11 is covered by the generated power of the first generator 121a and the generated power of the second generator 121b. At 7:00 and 18:00, the power demand of the consumer 11 is covered by the generated power (reference numeral 502) of the first generator 121a, the generated power (reference numeral 503) of the second generator 121b, and the purchased power (reference numeral 505). At 9:00 and 16:00, the power demand of the consumer 11 is covered by the generated power (reference numeral 502) of the first generator 121a, the generated power (reference numeral 503) of the second generator 121b, the generated power (reference numeral 504) of the third generator 121c, and the purchased power (reference numeral 505). At 8:00, 11:00, 12:00, and 17:00, the power demand of the consumer 11 is covered by the generated power (reference numeral 502) of the first generator 121a, the generated power (reference numeral 503) of the second generator 121b, and the generated power (reference numeral 504) of the third generator 121c. At 10:00, 13:00, 14:00, and 15:00, the power demand of the consumer 11 is covered by the generated power (reference numeral 502) of the first generator 121a, the generated power (reference numeral 503) of the second generator 121b, the generated power (reference numeral 504) of the third generator 121c, and the discharge power (reference numeral 506a) of the storage battery 122.

The data generation unit 101 may generate an operation plan on the basis of an optimization calculation using a physical model of each apparatus or an operation plan using a statistical model for the purpose of minimizing an energy cost. Further, the data generation unit 101 may generate the operation plan on the basis of a past operation result of the energy system.

Next, FIG. 4 shows an example in which an operation constraint is violated. At 7:00, the generated power (reference numeral 502) of the first generator 121a shown in FIG. 4 and indicated by a white arrow is planned to generate power under a condition of less than the minimum load factor, and violates the operation constraint. Similarly, at the same 7:00, the generated power (reference numeral 503) of the second generator 121b shown in FIG. 4 and indicated by the white arrow is also planned to generate power under the condition of less than the minimum load factor, and violates the operation constraint. Further, the third generator 121c (reference numeral 504) shown in FIG. 4 is also planned to generate power under the condition of less than the minimum load factor, and violates the operation constraint.

That is, on the basis of the operation plan shown in FIG. 4, for example, although the energy system 12 supplies a plurality of types of energy to the consumer 11, the generator 121 operates under a condition of less than the minimum load factor and the like, which has low efficiency, so that the microgrid 1 cannot perform an operation with high energy efficiency.

Next, FIG. 5 shows an example in which the operation constraint is violated. At 11:00, the third generator 121c (reference numeral 504) shown in FIG. 5 and indicated by a white arrow violates the operation constraint conditions and is stopped.

That is, when the generator is stopped only for 1 hour regardless of the condition that once stopped, the generator cannot operate for 3 hours.

That is, when the energy system 12 is operated on the basis of the operation plan shown in FIG. 5, the apparatus cannot exhibit an original performance thereof, and the energy cost increases. Further, when the apparatus is operated under constraint violation conditions, there is a possibility that the performance of the apparatus is deteriorated quickly.

The data generation unit 101 calculates key performance indicators (KPIs) corresponding to the operation plans shown in FIGS. 3 to 5 as described above, outputs the calculated KPIs to the calculation result DB 104, and stores the calculated KPIs in the calculation result DB 104.

For example, the data generation unit 101 calculates, on the basis of the operation plan that satisfies various operation conditions for the energy system 12, each of the KPIs when each apparatus operates (see FIG. 3). In the present embodiment, the KPI is an energy cost that is a sum of a purchased power rate and a gas rate consumed by the energy system.

For example, the data generation unit 101 calculates, on the basis of the operation plan that violates the operation constraint conditions for the energy system 12, the KPI depending on a degree of violation of the KPI when each apparatus operates (see FIGS. 4 and 5). That is, if the degree of violation is large, the data generation unit 101 calculates a final KPI by adding a large positive value (penalty) to a reference value. On the other hand, if the degree of violation is small, the data generation unit 101 calculates the final KPI by adding a small positive value (penalty) to the reference value.

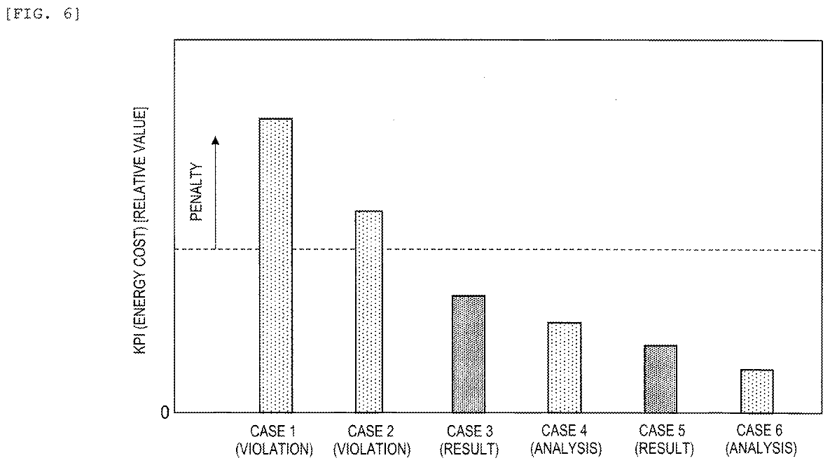

That is, the KPI has a small value when the KPI is calculated on the basis of the operation plan that satisfies the operation constraint conditions for the energy system 12, and has a large value when the KPI is calculated on the basis of the operation plan that violates the operation constraint conditions (see FIG. 6). Therefore, the operation plan that minimizes the KPI is the most desirable operation plan.

Here, the KPI calculated by the data generation unit 101 will be described with reference to FIG. 6. FIG. 6 is a diagram showing an example of the KPI.

Case 1 is a KPI (violation data) when each apparatus operates on the basis of the operation plan that violates the operation constraint conditions for the energy system 12, and is an operation plan that has a large KPI and that should not be performed. Case 2 is a KPI (violation data) when each apparatus operates on the basis of an operation plan that violates the operation constraint conditions for the energy system 12, and is an operation plan that has a large KPI and that should not be performed.

Cases 3 and 5 are KPIs (result data) when each apparatus operates on the basis of operation plans that satisfy the operation constraint conditions for the energy system 12 (past result), and the violation of the operation constraint does not occur. Cases 4 and 6 are KPIs (analysis data) when each apparatus operates on the basis of operation plans that satisfy the operation constraint conditions for the energy system 12 (analysis from a computer using the physical model and the statistical model), and the violation of the operation constraint does not occur.

The machine learning unit 102 learns system characteristics of the microgrid 1 on the basis of the KPI calculated by the data generation unit 101 as shown in FIG. 6, outputs the system characteristics to the learning result DB 105, and stores the system characteristics in the learning result DB 105. That is, the machine learning unit 102 considers not only data when the operation constraint conditions are satisfied (result data and analysis data), but also data when the operation constraint conditions are violated (violation data), and learns the system characteristics of the microgrid 1.

Machine learning can be classified into various algorithms according to purposes and conditions, such as supervised learning, unsupervised learning, semi-supervised learning, and reinforcement learning. In the present embodiment, for example, an algorithm of the reinforcement learning of giving a reward so that the machine learning unit automatically learns an action for reaching a target can be used. A known learning method can be applied as the algorithm of the reinforcement learning, and examples thereof include a Q learning method, a SARSA method, a TD learning method, and an AC method.

By an interaction between the machine learning unit 102, which is a learning subject, and the microgrid 1, which is a control target, learning and actions of the reinforcement learning are promoted on the basis of an effect of the action on an environment, so that a reward obtained in the future is maximized. The reinforcement learning has a feature that an action of exploiting an unknown learning field and an action of utilizing a known learning field can be selected in a well-balanced manner, and may find an appropriate target condition in a condition field that was completely unknown in the related art.

The operation plan generation unit 103 obtains various operation conditions on an operation day necessary for generating an operation plan from the microgrid 1 and further obtains the system characteristics from the learning result DB 105. Then, the operation plan generation unit 103 generates an optimal operation plan (an operation plan that minimizes the energy cost of the microgrid 1) on the basis of the various operation conditions and the system characteristics on the operation day, and outputs the generated operation plan to the microgrid 1. The various operation conditions on the operation day include, for example, a date and time on the operation day, a weather forecast on the operation day, a power price on the operation day, a gas price on the operation day, a predicted value of a power demand, a predicted value of a heat demand, and the like. The weather forecast on the operation day may be a value read at an interval of 30 minutes by the operation plan generation unit 103 on the operation day. Further, the predicted value of the power demand and the predicted value of the heat demand may be values calculated by a predetermined calculation device on the basis of information of the weather forecast on a day before the operation day.

The calculation result DB 104 stores the operation plans of a large number of cases generated by the data generation unit 101. For example, the calculation result DB 104 stores the operation plan that satisfies the operation constraint conditions for the energy system 12, the operation plan that violates the operation constraint conditions for the energy system 12, and the like. Further, the calculation result DB 104 stores a plurality of KPIs calculated by the data generation unit 101. For example, the calculation result DB 104 stores the KPI when each apparatus operates on the basis of the operation plan that satisfies the operation constraint conditions for the energy system 12, the KPI when each apparatus operates on the basis of the operation plan that violates the operation constraint conditions for the energy system 12, and the like.

The learning result DB 105 stores the system characteristics learned by the machine learning unit 102. The system characteristics are data related to characteristics of the energy system of the microgrid 1, the system characteristics are, for example, a start timing, a stop timing, an operation time, a load factor during operation of the generator 121, and a storage time and a discharge time of the storage battery 122, and similarly a heat storage time and a heat release time of the cold water C in the heat storage tank 126 suitable for the various operation conditions on the operation day.

According to the operation plan generation device 100 according to the present embodiment, on the basis of a combination of the plurality of operation plans and KPIs, the optimal operation plan is generated by causing the machine learning unit serving as artificial intelligence to learn the characteristics of the microgrid 1. Accordingly, even when the number of apparatuses in the microgrid increases, an operation plan generation device that generates a highly accurate (small energy cost) operation plan in a short time can be implemented. That is, a problem that as the number of the apparatuses in the microgrid 1 increases, a time required for the operation plan generation device 100 to generate the operation plan increases can be resolved without lowering the accuracy of the operation plan (without increasing the energy cost).

### «Operation of Operation Plan Generation Device»

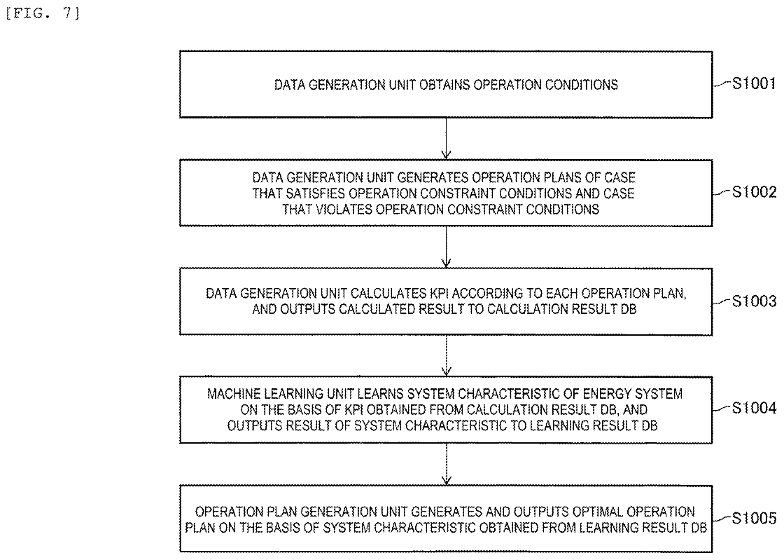

Next, an operation of the operation plan generation device 100 according to the present embodiment will be described with reference to FIG. 7.

In step S1001, the data generation unit 101 obtains the various operation conditions for the energy system 12 from the energy management system of the microgrid 1 including the consumer 11 and the energy system 12.

In step S1002, the data generation unit 101 generates the operation plan that satisfies the operation constraint conditions for the energy system 12 and the operation plan that violates the operation constraint conditions for the energy system 12.

In step S1003, the data generation unit 101 calculates the KPIs (energy costs) corresponding to the plurality of operation plans, and outputs the operation plans and the KPIs to the calculation result DB 104.

In step S1004, the machine learning unit 102 learns the system characteristics of the microgrid 1 on the basis of the KPIs obtained from the calculation result DB 104, and outputs the generated system characteristics to the learning result DB 105.

In step S1005, the operation plan generation unit 103 generates the optimal operation plan on the basis of the system characteristics obtained from the learning result DB 105, and outputs the generated optimal operation plan to the microgrid 1.

The calculation processing performed by the operation plan generation device 100 according to the present embodiment is completed by performing the above-described processing. The processing from step S1001 to step S1004 is performed offline in advance by the day before the operation day, and the processing of step S1005 is performed on the operation day, so that the time for generating the operation plan can be further reduced. According to the above-described operation plan generation method, the highly accurate operation plan can be generated in a short time. Further, the energy system 12 performs an appropriate operation on the basis of the operation plan, so that the energy cost of the microgrid 1 can be minimized. A flow shown in FIG. 7 is an example, and it is needless to say that a part of the flow can be omitted or other processing can be added.

### Second Embodiment

### «Configuration of Operation Plan Generation Device»

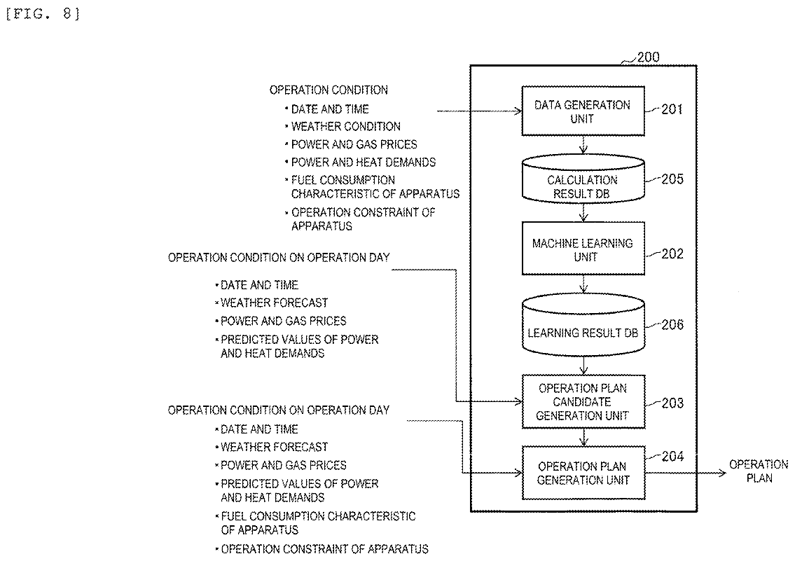

Next, an example of a configuration of an operation plan generation device 200 that is one function of the energy management system managing the operation of the microgrid 1 will be described with reference to FIG. 8. In the second embodiment, the same parts as in the first embodiment will not be described repeatedly.

The operation plan generation device 200 includes a data generation unit 201, a machine learning unit 202, an operation plan candidate generation unit 203, an operation plan generation unit 204, a calculation result DB (database) 205, a learning result DB (database) 206, or the like.

The data generation unit 201 obtains various operation conditions from the energy management system of the microgrid 1 for a large number of different cases in the energy system 12, and generates an operation plan (teacher data in the present embodiment) on the basis of the various operation conditions. At this time, the data generation unit 201 generates an operation plan that satisfies the operation constraint conditions for the energy system 12 and minimizes the energy cost of the microgrid 1. Here, the data generation unit 201 may generate an operation plan on the basis of the optimization calculation using the physical model of each apparatus and an operation plan using the statistical model, and an operation plan on the basis of a past operation result of the energy system. Further, the data generation unit 201 outputs the generated operation plan to the calculation result DB 205, and stores the generated operation plan in the calculation result DB 205. The operation constraint conditions include a minimum load factor of an apparatus, an upper limit value of the number of start and stop times per day of the apparatus, a continuation time after a start of the apparatus, a stop continuation time of the apparatus, or the like. In the first embodiment, the various operation conditions and the operation plans and the KPIs corresponding thereto are used as learning data for causing the machine learning unit 102 to learn, whereas in the second embodiment, the various operation conditions and the operation plans corresponding thereto are used as learning data (teacher data) for causing the machine learning unit 202 to learn.

The machine learning unit 202 learns system characteristics of the microgrid 1 on the basis of the operation plan calculated by the data generation unit 201, outputs the generated system characteristics to the learning result DB 206, and stores the generated system characteristics in the learning result DB 206. In the present embodiment, for example, an algorithm of deep learning using a multilayered neural network can be adopted.

The operation plan candidate generation unit 203 obtains, from the energy management system of the microgrid 1, the various operation conditions necessary for generating an operation plan candidate, and further obtains the system characteristics from the learning result DB 206. Then, the operation plan candidate generation unit 203 generates a plurality of operation plan candidates on the basis of the various operation conditions and the system characteristics, and outputs the plurality of operation plan candidates to the operation plan generation unit 204. The various operation conditions include, for example, a date and time on an operation day, a weather forecast of the date and time on the operation day, a power price of the date and time on the operation day, a gas price of the date and time on the operation day, a predicted value of a power demand, a predicted value of a heat demand, or the like.

The operation plan generation unit 204 obtains, from the energy management system of the microgrid 1, the various operation conditions necessary for generating the operation plan, and further obtains the plurality of operation plan candidates from the operation plan candidate generation unit 203. Further, the operation plan generation unit 204 receives input of the operation constraint conditions such as the minimum load factor of the apparatus, the upper limit value of the number of start and stop times per day of the apparatus, the continuation time after the start of the apparatus, the stop continuation time of the apparatus. Further, the operation plan generation unit 204 receives input of fuel consumption characteristic data of the apparatus using a weather condition as a parameter in order to consider a fuel consumption (power consumption and gas consumption) of the apparatus that changes depending on the weather condition. Then, the operation plan generation unit 204 generates (or selects) the optimal operation plan (the operation plan that minimizes the energy cost of the microgrid 1) on the basis of the various operation conditions and the plurality of operation plan candidates, and outputs the generated optimal operation plan to the microgrid 1.

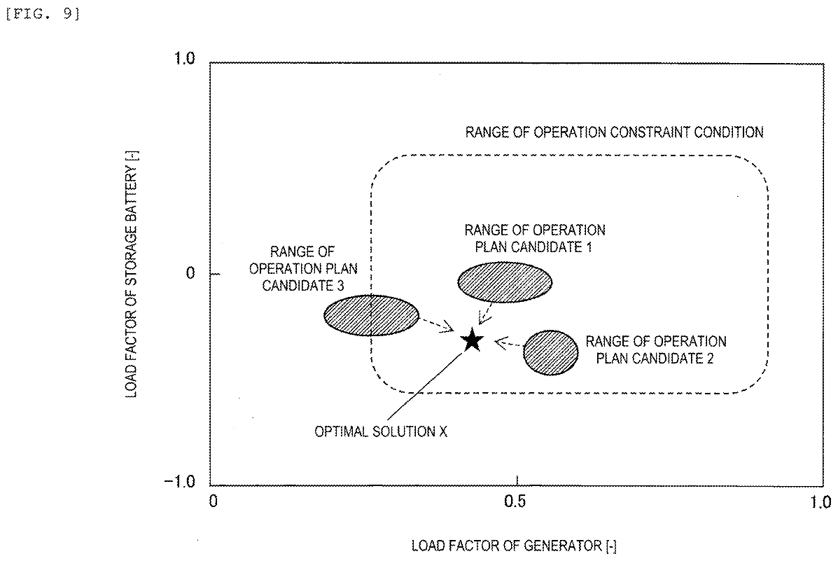

The operation plan generation unit 204 selects the plurality of operation plan candidates from the operation plan generation unit 203, and generates the optimal operation plan by performing a calculation by using the physical model or the statistical model and using the plurality of operation plan candidates as excellent initial solutions for the optimization calculation. Details of the point that the operation plan generation unit 204 generates the optimal operation plan will be described later with reference to FIG. 9, and the operation plan generation unit 204 can generate the optimal operation plan in a short time by utilizing the excellent initial solutions. That is, the machine learning unit 202 learns the system characteristics in advance by machine learning, and the operation plan candidate generation unit 203 generates the operation plan candidates (excellent initial solutions) on the basis of the system characteristics. The operation plan generation unit 204 can start a calculation for generating the operation plan with an excellent initial solution having good conditions as an initial value. Accordingly, a time required for the operation plan generation device 200 to generate the operation plan can be significantly reduced.

The operation plan generation unit 204 selects an excellent initial solution on the basis of the plurality of operation plan candidates, and performs the optimization calculation using the physical model of each apparatus or the calculation using the statistical model of each apparatus with the excellent initial solution as an initial value. The operation plan generation unit 204 can generate the optimal operation plan in a short time by utilizing the excellent initial solution. That is, the machine learning unit 202 learns the system characteristics in advance by machine learning, and the operation plan candidate generation unit 203 generates the operation plan candidates (excellent initial solutions) on the basis of the system characteristics. The operation plan generation unit 204 can start a calculation for generating the operation plan with an excellent initial solution having good conditions as an initial value. Accordingly, a time required for the operation plan generation device 200 to generate the operation plan can be significantly reduced.

Here, the operation plan candidates generated by the operation plan candidate generation unit 203 will be described with reference to FIG. 9. FIG. 9 is a diagram showing an example of the plurality of operation plan candidates at a certain time cross-section. The horizontal axis indicates the load factor of the generator, and the vertical axis indicates the load factor of the storage battery.

As shown in FIG. 9, an operation plan candidate 1 and an operation plan candidate 2 are included in a range of the operation constraint conditions. Therefore, by performing a calculation using solutions included in the operation plan candidate 1 and the operation plan candidate 2 as excellent initial solutions, the operation plan generation unit 204 can generate an operation plan in which operations of the generator 121 and the storage battery 122 satisfy the operation constraint conditions.

On the other hand, a part of an operation plan candidate 3 is included in the range of the operation constraint conditions, but the other part of the operation plan candidate 3 is not included in the range of the operation constraint conditions. Therefore, the operation plan generation unit 204 can start a calculation by using excellent initial solutions included in the operation plan candidate 3 and perform the optimization calculation while considering the operation constraint conditions, so as to generate the operation plan in which the operations of the generator 121 and the storage battery 122 satisfy the operation constraint conditions.

As shown in FIG. 9, an optimal solution (indicated by a star mark in FIG. 9) is selected on the basis of the operation plan candidate 1, the operation plan candidate 2, and the operation plan candidate 3. At this time, by performing the calculation using the excellent initial solution as an initial value and considering fuel consumption characteristics of the apparatus that satisfies the operation constraint conditions for the energy system 12 and is suitable for the weather condition on the operation day, the operation plan generation unit 204 can generate the operation plan that minimizes the energy cost of the microgrid 1.

The calculation result DB 205 stores a large number of operation plans generated by the data generation unit 201. For example, the calculation result DB 205 stores an operation plan that satisfies the operation constraint conditions for the energy system 12 and minimizes the energy cost of the microgrid 1.

The learning result DB 206 stores the system characteristics learned by the machine learning unit 202. The system characteristics are data related to characteristics of the energy system 12 of the microgrid 1, the system characteristics are, for example, a start timing, a stop timing, an operation time, a load factor during operation of the generator 121, and a storage time and a discharge time of the storage battery 122 suitable for the various operation conditions.

According to the operation plan generation device 200 according to the present embodiment, on the basis of the large number of operation plans, the plurality of operation plan candidates are generated by causing the machine learning unit serving as artificial intelligence to learn the characteristics of the energy system of the microgrid 1. Further, an excellent initial solution is selected on the basis of these candidates, and the optimal operation plan is generated. Accordingly, even when the number of apparatuses in the microgrid increases, an operation plan generation device that generates a highly accurate (small energy cost) operation plan in a short time can be implemented.

### «Operation of Operation Plan Generation Device»

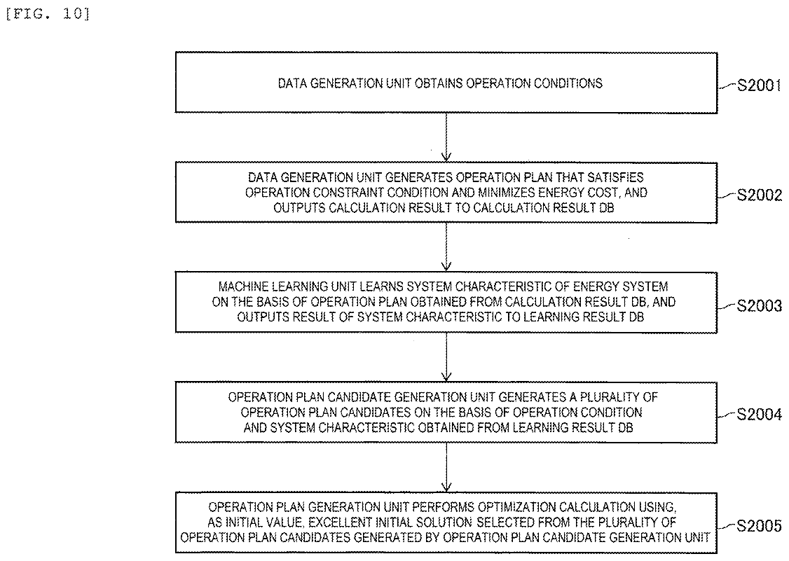

Next, an operation of the operation plan generation device 200 according to the present embodiment will be described with reference to FIG. 10.

In step S2001, the data generation unit 201 obtains a large number of the various operation conditions for the energy system 12 from the energy management system of the microgrid 1.

In step S2002, the data generation unit 201 generates the operation plan that satisfies the operation constraint conditions for the energy system 12 and minimizes the energy cost of the microgrid 1, and outputs the calculation result to the calculation result DB 205.

In step S2003, the machine learning unit 202 learns the system characteristics of the microgrid 1 on the basis of the large number of operation plans obtained from the calculation result DB 205, and outputs the generated system characteristics to the learning result DB 206.

In step S2004, the operation plan candidate generation unit 203 generates a plurality of operation plan candidates on the basis of the various operation conditions on the operation day and the system characteristics obtained from the learning result DB 206, and outputs the plurality of operation plan candidates to the operation plan generation unit 204.

In step S2005, the operation plan generation unit 204 selects an excellent initial solution on the basis of the various operation conditions on the operation day and the plurality of operation plan candidates generated by the operation plan candidate generation unit 203, performs the optimization calculation using the excellent initial solution as an initial value, generates the optimal operation plan, and outputs the generated optimal operation plan to the microgrid 1. At this time, in the optimization calculation, the operation plan that satisfies the operation constraint conditions and has a lower energy cost can be implemented by inputting the fuel consumption characteristics of the apparatus that uses the operation constraint conditions for the energy system 12 and the weather condition on the operation day as parameters and performing the optimal calculation.

The calculation processing performed by the operation plan generation device 200 according to the present embodiment is completed by performing the above-described processing. According to the above-described operation plan generation method, the highly accurate operation plan can be generated in a short time. Further, the processing from step S2001 to step S2003 is performed offline in advance by the day before the operation day, and the processing of step S2004 and step S2005 is performed on the operation day, so that the time for generating the operation plan can be further reduced. A flow shown in FIG. 10 is an example, and it is needless to say that a part of the flow can be omitted or other processing can be added.

### REFERENCE SIGN LIST

1: microgrid
11: consumer
12: energy system
100, 200: operation plan generation device
101, 201: data generation unit
102, 202: machine learning unit
103, 204: operation plan generation unit
203: operation plan candidate generation unit
A: power
B: hot water
C: cold water
D: gas

1. An operation plan generation device in an energy system that supplies energy to a consumer, the operation plan generation device comprising:
a data generation unit configured to generate, on the basis of a plurality of operation conditions for the energy system, a plurality of operation plans with respect to the respective operation conditions, and calculate KPIs corresponding to the respective operation plans;
a machine learning unit configured to learn characteristics of the energy system on the basis of the plurality of operation plans and the KPIs; and
an operation plan generation unit configured to generate an operation plan on the basis of the learned characteristics of the energy system.

2. The operation plan generation device according to claim 1,
wherein the data generation unit is configured to generate:
an operation plan that satisfies an operation constraint condition for the energy system; and
an operation plan that violates the operation constraint condition for the energy system.

3. The operation plan generation device according to claim 2,
wherein the KPIs change depending on a degree of violation of the operation constraint condition for the energy system.

4. The operation plan generation device according to claim 1,
wherein the machine learning unit is configured to learn the characteristics of the energy system by using reinforcement learning.

5. An operation plan generation device in an energy system that supplies energy to a consumer, the operation plan generation device comprising:
a data generation unit configured to generate a plurality of operation plans that satisfy an operation constraint condition for the energy system;
a machine learning unit configured to learn characteristics of the energy system on the basis of the plurality of operation plans;
an operation plan candidate generation unit configured to generate a plurality of operation plan candidates on the basis of the learned characteristics of the energy system; and
an operation plan generation unit configured to generate an operation plan on the basis of the plurality of operation plan candidates.

6. The operation plan generation device according to claim 5,
wherein the machine learning unit is configured to learn the characteristics of the energy system by using deep learning.

7. An operation plan generation method in an energy system that supplies a plurality of types of energy to a consumer, the operation plan generation method comprising:
a step of generating respective operation plans on the basis of a plurality of operation conditions for the energy system, and calculating KPIs corresponding to the operation plans;
a step of learning characteristics of the energy system on the basis of the plurality of operation plans and the KPIs, and generating learning data; and
a step of generating an operation plan on the basis of the learned characteristics of the energy system.

8. An operation plan generation method in an energy system that supplies energy to a consumer, the operation plan generation method comprising:
a step of generating a plurality of operation plans that satisfy an operation constraint condition for the energy system;
a step of learning characteristics of the energy system on the basis of the plurality of operation plans;
a step of generating a plurality of operation plan candidates on the basis of the learned characteristics of the energy system; and
a step of generating an operation plan on the basis of the plurality of operation plan candidates.

9. The operation plan generation device according to claim 2,
wherein the machine learning unit is configured to learn the characteristics of the energy system by using reinforcement learning.

10. The operation plan generation device according to claim 3,
wherein the machine learning unit is configured to learn the characteristics of the energy system by using reinforcement learning.
